(19) United States
(12) Patent Application Publication
(10) Pub. No.: US 2026/0101837 A1
(43) Pub. Date: Apr. 16, 2026

(54) FERTIGATION SYSTEM, APPARATUS, METHOD OF MAKING AND USING THE SAME

(71) Applicant: This Land, Inc., dba Sunday, Boulder, CO (US)

(72) Inventors: Justin Coulter LEWIS, Lafayette, CO (US); David Trent LEWIS, Boulder, CO (US); Joseph Charles Pius GRIEBEL, Westminster, CO (US); Ryan Eric PEDERSEN, Eerie, CO (US); Jesse Robert MCCLURE, Longmont, CO (US)

(21) Appl. No.: 19/359,329

(22) Filed: Oct. 15, 2025

Related U.S. Application Data
(60) Provisional application No. 63/707,684, filed on Oct. 15, 2024.

(51) Int. Cl. A01C 23/04; A01C 23/00

(52) U.S. Cl. CPC A01C 23/042; A01C 23/007

(57) ABSTRACT

The present disclosure provides a fertigation apparatus comprising a housing. The housing comprises a first inlet configured to receive pressurized water and a second inlet configured to receive chemicals. The housing further comprises a pump in fluid communication with the second inlet and a power source configured to provide power to the pump. The housing includes a flexible housing conduit in fluid communication with the pump and an actuator in electronic communication with the power source and pump, wherein when activated the actuator substantially simultaneously activates the pump and valve to allow flow from the first inlet. The housing also comprises a nozzle in fluid communication with the first inlet and second inlet, wherein the nozzle is in fluid communication with the pump and configured to mix chemicals and water at predetermined concentration.

### CROSS-REFERENCE TO RELATED APPLICATIONS

This application claims the benefit under 35 U.S.C. § 119(e) to U.S. Provisional Patent Application Ser. No. 63/707,684 entitled “Fertigation System, Apparatus, Method Of Making And Using The Same” filed Oct. 15, 2024, which is hereby incorporated by reference in its entirety.

### FIELD OF INVENTION

The present disclosure relates to fertigation systems and apparatus for agricultural applications, and more particularly to a fertigation apparatus comprising a housing configured to receive water and chemical inlets, a pump, and a nozzle configured to mix chemicals and water at predetermined concentrations for dispensing fertilizers, pesticides, herbicides, and other agricultural treatments.

### BACKGROUND

Fertigation, the practice of applying fertilizers and other agricultural chemicals through irrigation systems, has become an increasingly common method for delivering nutrients and treatments to crops and landscaping. This approach allows for the simultaneous application of water and various chemical treatments, including fertilizers, pesticides, herbicides, fungicides, and soil amendments, through a single delivery system.

Traditional fertigation systems often rely on venturi-based mixing mechanisms that create vacuum or low-pressure conditions to draw chemicals into the water stream. These systems typically require specific pressure differentials to function properly and may have limitations in terms of mixing precision and operational flexibility. The reliance on pressure differentials can also limit the types of chemicals that can be effectively dispensed and may result in inconsistent mixing ratios under varying pressure conditions.

Many existing fertigation systems lack integrated monitoring and control capabilities, making it difficult for users to track application rates, monitor chemical concentrations, or maintain records of treatment applications. This can lead to over-application or under-application of chemicals, potentially resulting in inefficient use of resources, environmental concerns, or suboptimal plant health outcomes.

The integration of digital technologies and wireless communication capabilities into agricultural equipment has opened new possibilities for precision agriculture applications. Modern fertigation systems can benefit from sensors, controllers, and communication modules that enable remote monitoring, automated operation, and data collection for improved management of chemical applications.

There remains a need for fertigation apparatus that can provide precise mixing of chemicals with water without relying on vacuum-based systems, while incorporating modern digital capabilities for enhanced monitoring, control, and data management. Such systems would benefit from simplified operation, improved mixing accuracy, and the ability to integrate with mobile devices and network-based management platforms for comprehensive treatment planning and record keeping.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a fertigation apparatus is provided. The fertigation apparatus comprises a housing. The housing comprises a first inlet configured to receive pressurized water and a second inlet configured to receive one or more chemicals or components. The housing further comprises a pump in fluid communication with the second inlet and a power source configured to provide power to the pump. The housing includes a flexible housing conduit in fluid communication with the pump and an actuator in electronic communication with the power source and the pump, wherein when the actuator is activated it substantially simultaneously activates the pump and a valve to allow flow from the first inlet. The housing also comprises a nozzle in fluid communication with the first inlet and the second inlet, wherein the nozzle is in fluid communication with the pump and configured to mix the one or more chemicals and water at a predetermined concentration.

According to other aspects of the present disclosure, the fertigation apparatus may include one or more of the following features. The fertigation apparatus may further comprise a sensor configured to measure one or more of a flowrate, a volumetric flow rate, a concentration of the one or more chemicals, flow, whether the fertigation apparatus is on or off, information indicative of an identification of the one or more chemicals. The fertigation apparatus may further comprise one or more of a position sensor, a location sensor, an accelerometer sensor, a temperature sensor, a radar sensor, and combinations of the same and the like. The fertigation apparatus may further comprise a printed circuit board. The fertigation apparatus may further comprise a wireless low power communication unit configured to be in communication with one of a mobile device or a computer. The wireless low power communication unit may be configured to utilize one or more of the following wireless standard protocols ZigBee protocol, Z-Wave protocol, Bluetooth Low Energy (BLE) protocol, Wi-Fi HaLow (IEEE 802.11 ah) protocol, LPWAN protocol, LoRaWAN protocol, SigFox protocol, NB IoT protocol, and LTE-M protocol. The wireless low power communication unit may be configured to utilize one or more of a wireless personal area network (WPAN), wireless local area network (WLAN), and wireless wide area network (WWAN). The fertigation apparatus may further comprise a controller in communication with the wireless low power communication unit. The controller may be configured to actuate the actuator in response to an input. The power source may comprise one or more of a battery, solar power, hydropower via turbine inline, combinations of the same and the like. The fertigation apparatus may further comprise one of more of a flowrate sensor, a concentration sensor, a temperature sensor, a RFID (passive or active) unit, a controller, a microcontroller, a printed circuit board, a power sensor, a location sensor, a global positioning sensor, an accelerometer, a motion sensor, weather sensor, combinations of the same and the like. The pressurized water may have a pressure in a range from about 40 psi to about 80 psi or less in static/non-flow pressure state. The pressurized water may have a pressure in a range from about 1 psi to about 40 psi or less in dynamic/flow pressure state. The one or more chemicals may comprise one or more of a fertilizer, a pesticide, a herbicide, a biological, a fungicide, an insecticide, a soil amendment, fragrance, and combinations of the same and the like. The fertilizer may comprise one or more of a nitrogen component, a phosphorous component, a potassium component, a micronutrient component and combinations of the same and the like. The pesticide may comprise one or more of an insecticide/repellant component, a herbicide component, a fungicide component, a rodenticide component and combinations of the same and the like. The biological may comprise one or more of a biostimulant component, a microbial inoculant component, a biofertilizer component, a biopesticide component and combinations of the same and the like. The soil amendment may comprise one or more of a pH adjustment component, a compost component, a surfactant component, a wetting agent and combinations of the same and the like. The fragrance may comprise one or more of an essential oil component, an enzyme component, an aroma compound component, a perfume component, a component configured to provide an agreeable scent and combinations of the same and the like. The scent may comprise one or more of a citrus scent, a floral scent, a cedar scent, an apple scent, a lavender scent, a cherry scent, a bergamot orange scent, an amber scent, a cinnamon scent, a fig scent, a mango scent, a sandalwood scent, an apple blossom scent, a fruity scent, a grapefruit scent, a lemon scent, an aquatic scent, a baby powder scent, a bluebell scent, a cantaloupe scent, a green grass scent, and combinations of the same and the like. The pump may comprise a continuous pump configured to be modulated at predetermined duty cycle. The predetermined duty cycle may be within a range of 0.1-10 Hz or greater. The pump may comprise a peristaltic pump, a gear pump, a diaphragm pump or combinations of the same and the like.

According to another aspect of the present disclosure, a fertigation apparatus is provided. The fertigation apparatus comprises a housing. The housing comprises a first inlet configured to receive pressurized water and a second inlet configured to receive one or more chemicals. The housing further comprises a pump in fluid communication with the second inlet and a power source configured to provide power to the pump. The housing includes a flexible housing conduit in fluid communication with the pump and an actuator in electronic communication with the power source and the pump, wherein when the actuator is activated it substantially simultaneously activates the pump source and a valve, wherein the valve configured to allow flow from the first inlet. The housing also comprises a nozzle in fluid communication with the first inlet and the second inlet, wherein the nozzle is in fluid communication with the pump and configured to mix the one or more chemicals and water at a predetermined concentration, and wherein the nozzle does not have a vacuum or a lower pressure during operation.

According to another aspect of the present disclosure, a fertigation system is provided. The fertigation system comprises a fertigation apparatus comprising a housing. The housing comprises a first inlet configured to receive pressurized water and a second inlet configured to receive one or more chemicals. The housing further comprises a pump in fluid communication with the second inlet and a power source configured to provide power to the pump. The housing includes a flexible housing conduit in fluid communication with the pump and an actuator in electrical communication with the power source and the pump, wherein when the actuator is activated it substantially simultaneously provides power to the pump and opens a valve configured to allow flow from the first inlet. The housing also comprises a nozzle in fluid communication with the first inlet and the second inlet, wherein the nozzle is in fluid communication with the pump and configured to mix the one or more chemicals and water at a predetermined concentration. The fertigation system further comprises a sensor module, a wireless communication unit, and a controller electrically connected the wireless communication unit and the sensor module, the controller being configured to establish a communication link to a wireless mobile device using a short-range wireless communication protocol including sending information indicative of one or more: information indicative of an identification of the fertigation apparatus, information indicative of a user identification, information indicative of a treatment time, information indicative of a treatment location, information indicative of a treatment concentration, and information indicative of the one or more chemicals. The fertigation system also comprises a network based data processing system comprising a data storage system and a processor, configured to receive data from the wireless mobile device.

According to other aspects of the present disclosure, the fertigation system may include one or more of the following features. A sensor module may be configured to output data indicative of one or more of a flowrate of the first inlet, a flowrate of the second inlet, a pressure of the first input, a pressure of the second inlet, a concentration of the one or more chemicals combinations of the same and the like. The fertigation system may further comprise a location module configured to output data indicative of one or more of a vibration, a movement, acceleration, and location of the fertigation apparatus. The sensor module may be further configured to provide one or more of: (i) location of the fertigation apparatus, and (ii) GPS tracking information. The network based data processing system may be further configured to generate a report for an end user. The report may comprise information indicative of inventory of one or more chemicals for an end user. The report may include correlated information indicative of fertigation schedule for an end user, fertilizer plan for an end user, inventory of fertilizer.

According to another aspect of the present disclosure, a fertigation system is provided. The fertigation system comprises a fertigation apparatus comprising a housing. The housing comprises a first inlet configured to receive pressurized water and a second inlet configured to receive one or more chemicals. The housing further comprises a pump in fluid communication with the second inlet and a power source configured to provide power to the pump. The housing includes a flexible housing conduit in fluid communication with the pump and an actuator in electrical communication with the power source and the pump, wherein when the actuator is activated it substantially simultaneously provides power to the pump and opens a valve configured to allow flow from the first inlet. The housing also comprises a nozzle in fluid communication with the first inlet and the second inlet, wherein the nozzle is in fluid communication with the pump and configured to mix the one or more chemicals and water at a predetermined concentration. The fertigation system further comprises one or more sensor modules, a wireless communication unit, and a controller electrically connected to the wireless communication unit and the one or more sensor modules, the controller being configured to establish a communication link to a wireless mobile device using a short-range wireless communication protocol, receive information from the wireless mobile device, and send information to the wireless mobile device. The fertigation system also comprises a network based data processing system comprising a data storage system and a processor configured to receive data from the wireless mobile device directly or indirectly and/or receive data from the fertigation apparatus directly or indirectly.

According to another aspect of the present disclosure, a method of using one of more of the fertigation apparatus and fertigation systems is provided.

The foregoing general description of the illustrative embodiments and the following detailed description thereof are merely exemplary aspects of the teachings of this disclosure and are not restrictive.

### BRIEF DESCRIPTION OF FIGURES

The accompanying drawings, which are included to provide a further understanding of the invention and are incorporated in and constitute a part of this specification, illustrate embodiments of the invention and together with the description serve to explain the principles of the invention.

FIG. 1 illustrates a top view of a fertigation apparatus, according to aspects of the present disclosure.

FIG. 2 illustrates a side view of the fertigation apparatus of FIG. 1, according to aspects of the present disclosure.

FIG. 3 illustrates an end view of the fertigation apparatus of FIG. 1, according to aspects of the present disclosure.

FIG. 4 illustrates an exploded view of the fertigation apparatus of FIG. 1, according to aspects of the present disclosure.

FIG. 5 illustrates an exploded view of the fertigation apparatus of FIG. 1, according to aspects of the present disclosure.

FIG. 6 illustrates a magnified exploded view of the fertigation apparatus showing a switch, according to aspects of the present disclosure.

FIG. 7 illustrates a top view of the fertigation apparatus in different operational configurations, according to aspects of the present disclosure.

FIG. 8 illustrates a diagram of an exemplary fertigation system, according to aspects of the present disclosure.

FIG. 9 illustrates a diagram of an exemplary communication system, according to aspects of the present disclosure.

### DETAILED DESCRIPTION

For the purposes of promoting an understanding of the principles of the present disclosure, reference will now be made to the exemplary embodiments illustrated in the drawing(s), and specific language will be used to describe the same.

Appearances of the phrases an “embodiment,” an “example,” or similar language in this specification may, but do not necessarily, refer to the same embodiment, to different embodiments, or to one or more of the figures. The features, functions, and the like described herein are considered to be able to be combined in whole or in part one with another as the claims and/or art may direct, either directly or indirectly, implicitly or explicitly.

Functional units described in this specification may be labeled as modules, in order to more particularly emphasize their structural features. A module may be implemented as a hardware circuit comprising custom circuits, e.g., VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module of programmable or executable code may, for instance, comprise one or more physical or logical blocks of computer instructions which may, for instance, be organized as an object, procedure, or function. Components of a module need not necessarily be physically located together, but may, e.g., comprise disparate instructions stored in different locations which, when joined logically together, comprise the module and achieve the stated purpose for the module.

A module and/or a program of executable code may be a single instruction, or many instructions, and may even be distributed over several different code segments, among different programs, and across several memory devices. Similarly, data or input for the execution of such modules may be identified and illustrated herein as being an encoding of the modules, or being within modules, and may be embodied in any suitable form and organized within any suitable type of data structure.

The various system components and/or modules discussed herein may include one or more of the following a host server or other computing systems including a processor for processing digital data, a memory coupled to the processor for storing digital data, an input digitizer coupled to the processor for inputting digital data; an application program stored in one or more machine data memories and accessible by the processor for directing processing of digital data by the processor, a display device coupled to the processor and memory for displaying information derived from digital data processed by the processor, and a plurality of databases or data management systems.

The present disclosure may be described herein in terms of functional block components, screen shots, user interaction descriptions, optional selections, various processing steps, and the like. It should be appreciated that such descriptions may be realized by any number of hardware and/or software components configured to perform the functions described. Accordingly, to implement such descriptions, various integrated circuit components, e.g., memory elements, processing elements, logic elements, look-up tables, and the like may be used, which may carry out a variety of functions under the control of one or more microprocessors or other control devices. Similarly, the software elements of the present disclosure may be implemented with any programming or scripting language such as C, C++, Java, COBOL, assembler, PERL, Visual Basic, SQL Stored Procedures, AJAX, extensible markup language (XML), Flex, Flash, with the various algorithms being implemented with any combination of data structures, objects, processes, routines or other programming elements. Further, it should be noted that embodiments in the present disclosure may employ any number of conventional techniques for data transmission, signaling, data processing, network control, and the like as one skilled in the art will understand. Embodiments of the present disclosure may also include detection or prevention of security issues using various techniques. Additionally, many of the functional units and/or modules herein may be described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via a network, a wireless network, software, instructions, circuitry, phone lines, Internet lines, satellite signals, electric signals, electrical and magnetic fields and/or pulses, and/or so forth.

Communication among the components or parties in accordance with the present disclosure may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, embodiments of the disclosure may also be implemented using IPX, Appletalk, IP-6, NetBIOS, OSI or any number of existing or future protocols. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

As used herein, “comprising,” “including,” “containing,” “is,” “are,” “characterized by,” and grammatical equivalents thereof are inclusive or open-ended terms that do not exclude additional unrecited elements or method steps unless explicitly stated otherwise.

In order to more fully appreciate the present disclosure and to provide additional related features, the following references are incorporated therein by reference in their entirety and for the teachings referenced herein:
(1) U.S. Pat. No. 9,144,205 by Pease et al., which discloses ancillary embodiments and modifications to a homogenizer unit (“PPH”), and methods of use directed to hydroponics. The apparatus includes a homogenizer body, one or more nutrient stream inlets, one or more water inlets, a mixing zone where the water stream is commingled with the nutrient stream, and a venturi within the body immediately downstream from the mixing zone such that the commingled streams are pulled into the venturi resulting in homogenization. The PPH components are insulated to maintain the aqueous nutrient solution at a cooled, below ambient temperature. Because the prepared aqueous nutrient solution is cooled, it may also have oxygen and/or nitrogen gas dissolved therein (e.g., introduced into one of the streams introduced into the PPH). The resulting aqueous nutrient solution can be conveyed in its cooled state to roots of hydroponically grown plants to provide nutrients for the growth of the plants.
(2) U.S. Pat. No. 9,585,301 by Lund et al., which discloses an agricultural planter having sensors for measuring multiple soil properties adjusts planting depth and seeding rate in real time based on the measured soil properties. An optical module is carried by the planter for collecting soil reflectance data. A pair of soil contact blades protrude from or are embedded in the optical module for collecting soil EC data and soil moisture data. A switching circuit or phase lock loop allows the same soil contact blades to feed signals to both a soil EC signal conditioning circuit and a soil moisture signal conditioning circuit. The soil moisture data can be used to calibrate the soil EC data and the soil reflectance data to compensate for effects of changing soil moisture conditions across a field. The sensor module can be positioned behind a seed tube and used as a seed firmer, or incorporated into a seed tube guard.
(3) U.S. Pat. Publication No. 2016/0158783 by Wiebe, which discloses methods and apparatus, including computer program products, implementing and using techniques for controlling a sprinkler system are described. The sprinkler system includes one or more sprinkler units. At least some sprinkler units include: a variable speed rotation motor, a flow valve, and a control module. The variable speed rotation motor and the flow valve are configured to apply different amounts of water to different regions of an area irrigated by the sprinkler unit, in response to instructions received from the control unit.
(4) U.S. Pat. Publication No. 2017/0208757 by Valmont, which discloses a horticultural nutrient control system and method for using same. The invention relates to an apparatus, and related methods, for automatically formulating, storing, and dispensing a nutrient solution to one or more horticultural crop, comprising: a) a reservoir unit for receiving a nutrient solution, mixing said nutrient solution, and dispensing said nutrient solution to a corresponding horticultural crop, wherein said reservoir unit comprises: i) a vertical cylindrical tank terminating at a cone-shaped bottom outlet; ii) a plurality of vertical baffles extending from the interior surface of the reservoir unit; and iii) a plurality of fluid eductors positioned along the length of each baffle, said fluid eductors adapted to deliver said nutrient solution in combination with oxygen to said reservoir unit; b) a nutrient delivery assembly fluidly connecting a water source and a plurality of nutritional component sources to said reservoir unit, said nutrient delivery assembly adapted to controllably deliver said water and nutritional components to said reservoir unit through said plurality of fluid eductors; c) controller coupled to said nutrient delivery assembly and adapted to direct the delivery of said water and nutritional components to the reservoir unit; and d) a storage-control unit for housing at least a central processing unit, said nutrient delivery assembly, and said plurality of nutritional component sources, wherein said central processing unit is operably coupled to said controller.
(5) U.S. Pat. Publication No. 2021/0319489 by Coulter, et al., which discloses a method of determining a lawn treatment plan and delivering lawn treatments includes receiving at a user interface an address having a lawn. The method further includes determining an initial lawn size for the lawn based on the address. The method further includes receiving confirmation of the initial lawn size. The method further includes calculating a lawn treatment plan based on the initial lawn size. The method further includes providing the lawn treatment plan to a customer. The method further includes providing instruction for providing the lawn treatment plan to a fulfillment center. The method further includes delivering packetized lawn treatments according to the lawn treatment plan on a periodic basis to the customer for treatment of the lawn.

Embodiments of the invention are directed towards a subject behavior modification method and system that provides a system that can be used with a fertigation apparatus. In one embodiment, the system is configured to order, monitor, give tangible, and intangible rewards may include a score or ongoing ranking on a social media site or communicated over some other network. Moreover, a tangible reward may include an economic incentive, e.g., a reduction in treatments. By incorporating elements that reward behaviors the behavior can be modified. The reward is configured to induce behavior to increase use and application of the fertigation apparatus and comply with treatments times, durations, thereby achieving a predetermined behavior.

In one embodiment, the fertigation apparatus includes a housing including a first inlet configured to receive water, e.g., pressurized water, a second inlet configured to receive one or more chemicals, a pump in fluid communication with the second inlet, a power source configured to provide power to the pump, a flexible housing conduit in fluid communication with the pump, an actuator in electronic communication with the power source and the electric motor, and a nozzle in fluid communication with the first inlet and the second inlet, wherein the nozzle is in fluid communication with the pump and configured to mix the one or more chemicals and water at a predetermined concentration.

In one embodiment, the system is configured for determining a lawn treatment plan and includes a lawn treatment plan engine, the lawn treatment plan engine is configured to query a customer for an address having a lawn, receive the address, calculate an initial lawn size for the lawn based on the address, receive a confirmation of the initial lawn size, calculate a lawn treatment plan based on the initial lawn size, provide the lawn treatment plan to a customer, and provide instruction for providing the lawn treatment plan to a fulfillment center for delivering packetized lawn treatments according to the lawn treatment plan on a periodic basis to the customer for treatment of the lawn.

In one embodiment, the fertigation system includes a lawn engine configured to generate a treatment plan as described in U.S. patent Ser. No. 16/848,714 in one or more of a mobile device, a cell phone device, a tablet device, a computer, a microcomputer, distributed computer processing, combinations, of the same and the like.

In one embodiment, the fertigation apparatus includes an actuator configured to simultaneously activate the power source of a pump to allow flow of the one or more chemicals and a valve to allow flow from the first inlet.

In one embodiment, the actuator simultaneously activates the power source and a valve to allow flow from the first inlet.

In one embodiment, the nozzle includes a structure configured to create a partial vacuum inside the nozzle, thereby creating a low pressure area that draws and/or mixes through the nozzle. In one embodiment, the structure is configured to utilize one of the venturi effect.

In one embodiment, the fertigation system or apparatus includes one of more of a flowrate sensor, a concentration sensor, a temperature sensor, a RFID (passive or active) unit, a controller, a microcontroller, a printed circuit board, a power sensor, a location sensor, a global positioning sensor, an accelerometer, a motion sensor, weather sensor, combinations of the same and the like.

In one embodiment, the fertigation system includes a mobile device, a cell phone device, a tablet device, a computer, a microcomputer, combinations of the same and the like.

In one embodiment, a fertigation system, includes a fertigation apparatus and network device, e.g., mobile device, and processing system. The fertigation apparatus includes a first inlet configured to receive pressurized water, a second inlet configured to receive one or more chemicals, a pump in fluid communication with the second inlet, a power source configured to provide power to the pump, a flexible housing conduit in fluid communication with the pump, an actuator in electrical communication with the power source and the pump, wherein when the actuator is activated it simultaneously provides power to the pump and opens a valve configured to allow flow from the first inlet, a nozzle in fluid communication with the first inlet and the second inlet, wherein the nozzle is in fluid communication with the pump and configured to mix the one or more chemicals and water at a predetermined concentration, a sensor module, a wireless communication unit, a controller electrically connected the wireless communication unit and the sensor module, the controller being configured to: establish a communication link to a wireless mobile device using a short-range wireless communication protocol including sending information indicative of an identification of the fertigation apparatus and a network based data processing system comprising a data storage system configured to receive data from the controllable mobile device.

In one embodiment, the fertigation system is configured to establish a communication link to a wireless mobile device using a short-range wireless communication protocol including sending information from the wireless mobile device to the controller and
a network based data processing system comprising a data storage system configured to receive data from the controllable mobile device and/or the fertigation apparatus.

In one embodiment, the fertigation apparatus includes a housing, including a first inlet configured to receive pressurized water, a second inlet configured to receive one or more chemicals, a pump in fluid communication with the second inlet, a power source configured to provide power to the pump, a flexible housing conduit in fluid communication with the pump, an actuator in electronic communication with the power source and the pump, wherein when the actuator is activated it substantially simultaneously activates the power source and a valve, wherein the valve configured to allow flow from the first inlet and a nozzle in fluid communication with the first inlet and the second inlet, wherein the nozzle is in fluid communication with the pump and configured to mix the one or more chemicals and water at a predetermined concentration, and wherein the nozzle does not have a vacuum or a lower pressure during operation.

In one embodiment, the one or more chemicals comprises one or more of a fertilizer, a pesticide, a herbicide, a biological, a fungicide, an insecticide, a soil amendment, fragrance, and combinations of the same and the like.

In one embodiment, the fertilizer includes one or more of a nitrogen component, a phosphorous component, a potassium component, a micronutrient component and combinations of the same and the like.

In one embodiment, the pesticide includes one or more of an insecticide/repellant component, an herbicide component, a fungicide component, a rodenticide component and combinations of the same and the like.

In one embodiment, the biological includes one or more of a biostimulant component, a microbial inoculant component, a biofertilizer component, a biopesticide component and combinations of the same and the like.

In one embodiment, the soil amendment includes one or more of a component configured to adjust pH, a pH adjustment component, a compost component, a surfactant component, a wetting agent and combinations of the same and the like.

In one embodiment, the fragrance includes one or more of an essential oil component, an enzyme component, an aroma compound component, a perfume component, a component configured to provide an agreeable scent and combinations of the same and the like.

In one embodiment, the scent includes one or more of a citrus scent, a floral cent, a cedar sent, an apple scent, a lavender scent, a cherry scent, a bergamot orange scent, an amber scent, a cinnamon scent, a fig scent, a mango scent, a sandalwood scent, an apple blossom scent, a fruity scent, a grapefruit scent, a lemon scent, an aquatic scent, a baby powder scent, a bluebell scent, a cantaloupe scent, a green grass scent, and combinations of the same and the like.

The following description sets forth exemplary aspects of the present disclosure. It should be recognized, however, that such description is not intended as a limitation on the scope of the present disclosure. Rather, the description also encompasses combinations and modifications to those exemplary aspects described herein.

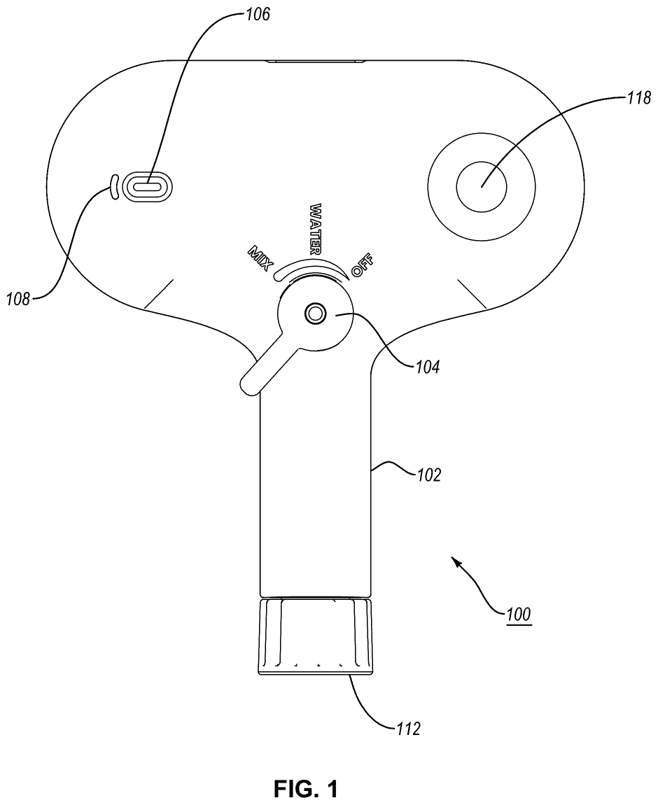

FIG. 1 illustrates a top view of a fertigation apparatus, according to aspects of the present disclosure. Referring to FIG. 1, a fertigation apparatus 100 may be configured to provide controlled mixing and dispensing of chemicals with pressurized water for agricultural and horticultural applications. The fertigation apparatus 100 includes a housing 102 that may contain various operational components and provide structural support for the apparatus.

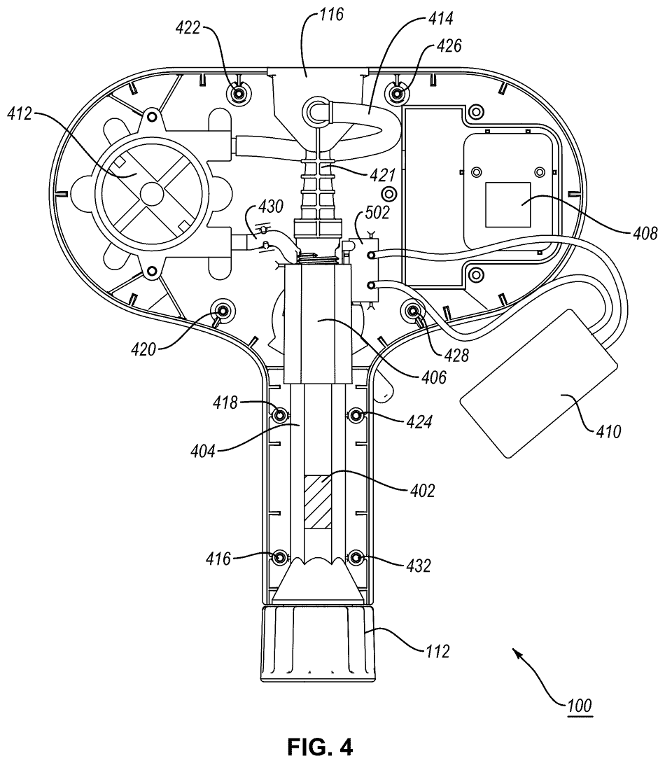

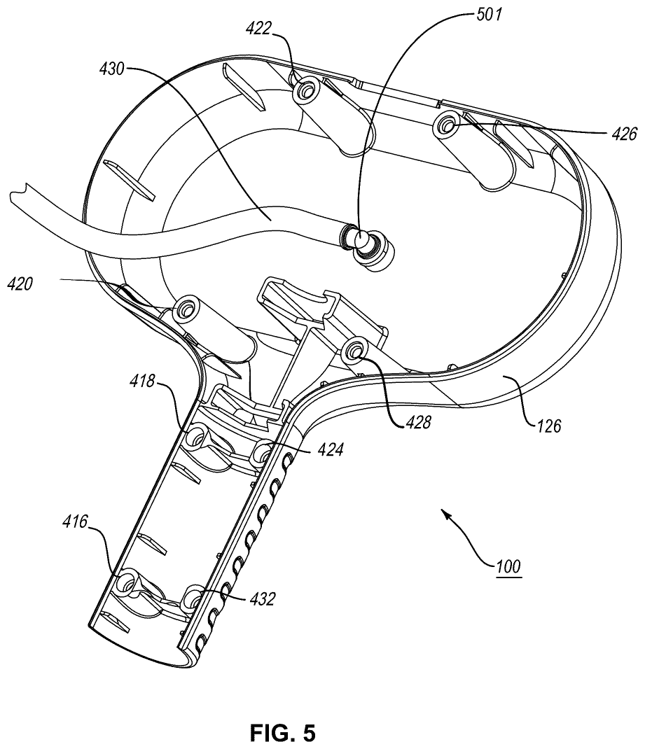

The housing 102 may be configured to accommodate one or more internal components while providing external access to control elements, interfaces, and connection points. In the illustrated embodiment, the housing 102 comprises a two-part assembly including a first half 124 and a second half 126. The first half 124 and the second half 126 are detachable and may be secured together using an attachment mechanism such as a screw, bolt, rivet, snap-fit system, or other suitable fastening mechanism. In certain embodiments, a sealing element such as an O-ring or gasket may be disposed between the halves to improve environmental resistance. Optionally, and/or alternatively, recesses 120 and 122 can be utilized to receive a screw in a recessed manner. Fasting holes 416, 418, 420, 422, 424, 426, 428, 430 and 432 are used to attached the first half to the second half in FIGS. 4-5. The fastening holes may have a threaded portion to receive a screw or snap-fit.

The fertigation apparatus 100 includes an actuator 104 that may be positioned on the housing 102 to enable user control of the apparatus operations. An input power port 106 may be located on the housing 102 to provide electrical connection for powering the fertigation apparatus 100. The housing 102 may also include a power indicator 108 that may provide visual feedback regarding the operational status of the fertigation apparatus 100. In some cases, the power indicator 108 may illuminate to indicate when the fertigation apparatus 100 is receiving power or is in an active operational state.

A first inlet 112 may extend from the housing 102 to provide a connection point for receiving water input, e.g., pressurized water. The first inlet 112 may be configured with appropriate threading or coupling mechanisms to enable secure connection to water supply lines or hoses. The fertigation apparatus 100 may include a cutout or a window 118 to show components under the window. Optionally and/or alternatively, the fertigation apparatus 100 may further include a control knob positioned on the housing 102 to allow adjustment of operational parameters such as flow rates, mixing ratios, or operational modes. The control knob may provide tactile feedback to users during adjustment operations and may be configured to maintain selected settings during operation.

The housing 102 may be constructed from one or more materials including, but not limited to, metal, alloy, plastic materials, thermoplastic materials, polyvinyl chloride (PVC), polyethylene terephthalate (PET), polyether ether ketone (PEEK), acrylonitrile butadiene styrene (ABS), high-density polyethylene (HDPE), polycarbonate (PC), and combinations thereof. In certain embodiments, metallic or composite reinforcements such as aluminum inserts or glass fiber-reinforced polymers may also be used to enhance structural integrity. These materials may be selected to provide desired characteristics such as durability, mechanical strength, impact resistance, ultraviolet (UV) stability, and chemical and weather resistance suitable for outdoor agricultural or industrial applications. The housing 102 may utilize a clam shell design configuration that may enable access to internal components for maintenance, repair, or component replacement. In some cases, the clam shell design may include separable housing sections that may be joined together using fasteners, clips, or other mechanical connection methods. The clam shell configuration may provide manufacturing advantages by allowing assembly of internal components before final housing closure, and may facilitate field servicing of the fertigation apparatus 100 when maintenance is needed.

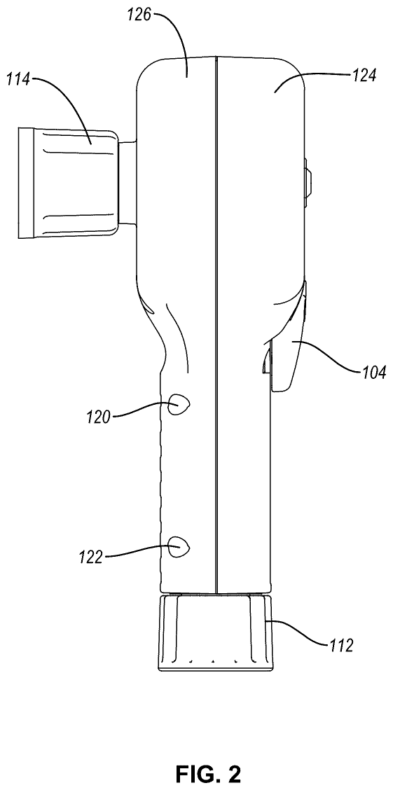

FIG. 2 illustrates a side view of the fertigation apparatus of FIG. 1, according to aspects of the present disclosure. Referring to FIG. 2, the fertigation apparatus 100 may be configured with a vertical arrangement that may provide efficient fluid handling and operational control. The housing 102 may extend to accommodate internal components while providing access points for fluid connections at different elevations. The vertical configuration of the housing 10 may enable gravity-assisted flow characteristics and may facilitate separation of different fluid pathways within the fertigation apparatus 100.

The housing 102 may include the first inlet 112 positioned at a lower portion of the housing 102 to receive pressurized water input. The first inlet 112 may be configured with appropriate connection mechanisms to enable secure attachment to water supply systems or distribution networks. A second inlet 114 may be positioned at an upper portion of the housing 102 to provide a separate connection point for receiving chemicals or components. The second inlet 114 may be configured to accommodate various chemical containers, reservoirs, or supply lines that may deliver treatment materials to the fertigation apparatus 100. The separation between the first inlet 112 and the second inlet 114 may provide operational advantages by maintaining distinct fluid pathways and may reduce the potential for cross-contamination between water and chemical inputs.

The fertigation apparatus 100 may be configured to operate within specific pressure ranges that may accommodate various water supply systems and operational conditions. In some cases, the pressurized water received through the first inlet 112 may have a pressure in a range from about 40 psi to about 80 psi in static/non-flow pressure state. The static pressure range may correspond to typical municipal water supply pressures or pressurized irrigation system conditions when water flow is not actively occurring. During operational conditions when water flow is active, the fertigation apparatus 100 may function with pressurized water having a pressure in a range from about 1 psi to about 40 psi in a dynamic flow pressure state. As used herein, the dynamic pressure, also known as velocity pressure or flow pressure, is the pressure associated with the motion of a fluid. It represents the kinetic energy per unit volume of a moving fluid and quantifies the pressure rise that would occur if the fluid were brought to rest isothermally and without losses. The dynamic pressure range may account for pressure drops that may occur during active water flow through the fertigation apparatus 100 and associated distribution systems.

The pressure ranges may enable the fertigation apparatus 100 to function with various water supply configurations including municipal water systems, well water systems, and pressurized irrigation networks. The housing 102 may be constructed to withstand the operational pressures while maintaining structural integrity and leak-resistant performance. In some cases, the vertical arrangement of the housing 102 may provide mechanical advantages for pressure distribution and may enable efficient internal component placement. The positioning of the first inlet 112 and the second inlet 114 at different elevations may facilitate pressure management and may enable controlled mixing of pressurized water with chemicals or components during operation of the fertigation apparatus 100.

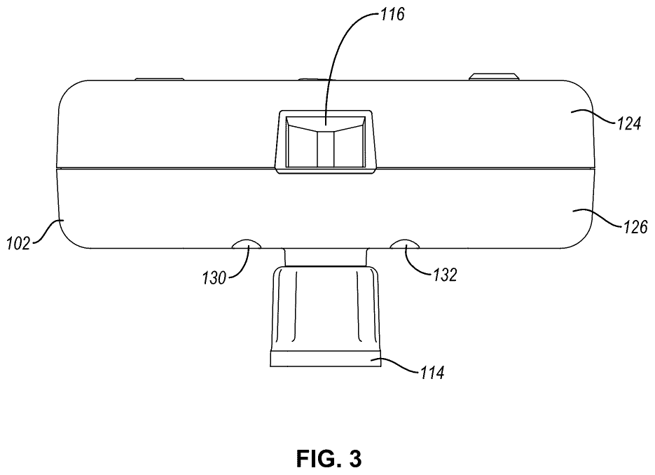

FIG. 3 illustrates an end view of the fertigation apparatus of FIG. 1, according to aspects of the present disclosure. Referring to FIG. 3, the fertigation apparatus 100 may be configured with a rectangular housing that may include rounded corners to provide structural advantages and aesthetic appeal. The rounded corners may reduce stress concentrations that might otherwise occur at sharp corner transitions and may provide improved durability during handling and operational use. The rectangular configuration of the housing may enable efficient internal component packaging while maintaining a compact overall footprint that may be suitable for various installation environments and storage configurations.

The fertigation apparatus 100 may include a mounting element that may be positioned at a bottom portion of the housing to provide stable attachment to surfaces, brackets, or support structures. The mounting element may be configured with appropriate fastening mechanisms, threaded connections, or mounting holes that may enable secure installation in various orientations and locations. In some cases, the mounting element may be designed to accommodate different mounting hardware configurations and may provide flexibility for installation on walls, posts, equipment racks, or other support structures. The positioning of the mounting element at the bottom portion of the housing may provide a low center of gravity that may enhance stability during operation and may reduce the potential for vibration or movement during fluid flow operations.

The housing may include an opening or window that may be positioned in an upper portion of the housing to provide visual access to internal components or operational indicators. The opening may enable users to observe internal component status, fluid levels, or operational conditions without requiring disassembly of the housing. In some cases, the opening may be covered with transparent materials such as glass or clear plastic that may protect internal components while maintaining visibility. The window positioning in the upper portion of the housing may provide convenient viewing angles for users and may enable monitoring of internal conditions during operation of the fertigation apparatus 100.

The end view may demonstrate the compact and streamlined design profile of the fertigation apparatus 100, showing overall proportions and dimensional characteristics when viewed from the end perspective. The streamlined configuration may provide advantages for installation in confined spaces and may reduce the overall footprint required for the fertigation apparatus 100 in various application environments. The compact design may enable multiple units to be installed in close proximity and may facilitate integration with existing irrigation or chemical application systems. The proportions shown in the end view may reflect design considerations for internal component accommodation while maintaining external dimensions that may be suitable for portable or fixed installation applications.

FIG. 4 illustrates an exploded view of the fertigation apparatus of FIG. 1, according to aspects of the present disclosure. Referring to FIG. 4, the fertigation apparatus 100 may be configured with internal components that may be arranged to enable controlled mixing and dispensing operations. The exploded view may demonstrate the spatial relationships and connection pathways between various internal elements that may work together to provide fertigation functionality. The internal arrangement may be designed to accommodate fluid flow management, electrical power distribution, and mechanical actuation systems within the housing 102.

The fertigation apparatus 100 may include the first inlet 112 that may be positioned to receive pressurized water input and direct the water flow through internal pathways. A nozzle 116 may be configured to provide mixing functionality and may be positioned to receive inputs from multiple sources during operation. The nozzle 116 may include a chemical outlet or inlet from a bottom portion of the nozzle 116 that may be configured to provide one or more chemicals into the pressurized water inlet. This bottom inlet configuration may enable controlled introduction of chemical materials into the water stream and may facilitate mixing operations within the nozzle 116. The nozzle 116 may further include a nozzle ramp at an angle that may be positioned at an angle of about 5 degrees to about 45 degrees or greater to provide flow characteristics that may enhance mixing efficiency and may direct the combined fluid output in a controlled manner. The slope creates suction or vacuum allowing the mixing or air gap effect of the chemical being provided.

A flow rate unit 402 may be incorporated into the fertigation apparatus 100 to provide flow measurement, e.g., flowrate and other attributes of the water such as pressure, temperature, flowrate, acceleration, and other properties. The apparatus also includes a valve assembly 406 connected to other internal components through fluid pathways. The valve assembly 406 may be configured to regulate water flow from the first inlet 112 and may enable selective activation of fertigation operations. A connection tube 404 may provide fluid communication between the valve assembly 406 and flow rate unit 402 and other internal components, and may be constructed from materials that may provide chemical resistance and pressure handling capabilities. The connection tube 404 may be sized and configured to accommodate the flow rates and pressures that may be encountered during normal operation of the fertigation apparatus 100.

The valve assembly 406 may include a ball valve or other valve assembly that may provide precise flow control and may be configured for rapid opening and closing operations. The ball valve may be positioned within the internal flow pathway and may be actuated through mechanical or electrical control systems. The ball valve may provide reliable sealing characteristics when in the closed position and may enable unrestricted flow when in the open position. In some cases, the ball valve 406 may be constructed from materials that may provide corrosion resistance and may maintain sealing performance over extended operational periods. The ball valve 406 may be configured to handle the pressure ranges that may be encountered during both static and dynamic operational conditions of the fertigation apparatus 100.

A power source, e.g., battery 410 may be incorporated into the fertigation apparatus 100 to provide electrical energy for various electronic components and systems. The power battery 410 may be configured as a rechargeable or replaceable power source that may enable portable operation of the fertigation apparatus 100. A power source 410 may provide regulated power to internal systems. The power source 410 may comprise a battery that may power electronics having one or more of a controller, microcontroller, printed circuit board, low power communication source, and memory. These electronic components may enable automated control functions, communication capabilities, and operational monitoring features that may enhance the functionality of the fertigation apparatus 100. A control unit 408 is shown. The control unit can include a controller, a memory, a printed circuit board (PCB) and a communication interface to communicate over the network 900 and between components herein.

The fertigation apparatus 100 may include a pump 412 that may be positioned to provide controlled movement of chemical materials from storage containers or reservoirs connected to the apparatus 100. The chemicals move from conduit 430 through the pump 412 to conduit 414 and then to the mixing location within the nozzle 116. The pump 412 may be configured as a positive displacement pump that may provide accurate flow control and may be capable of handling various chemical formulations that may be used in fertigation applications. In some cases, the pump 412 may be electrically powered by the power source 410 and may be controlled through electronic systems and communication system 900 that may regulate pumping rates and operational timing. The pump 412 may be constructed from materials that may provide chemical compatibility and may maintain performance characteristics over extended operational periods.

A venturi 421 may be incorporated into the fertigation apparatus 100 to provide additional flow control functionality and may be positioned to regulate chemical flow from the pump 412 to the nozzle 116. The venturi 421, which is optional or an air gap system configured to allow the chemical to be distributed directly into the nozzle stream. The air gap is also known as a Coandă effect. The venturi 421 reduces the pressure thereby allowing input of the chemical and mixing.

In one embodiment, the pump 412 is configured for precise flow control and may enable accurate dosing of chemical materials during mixing operations. The pump 412 may be actuated through electrical control systems that may coordinate valve operation with pump 412 operation and ball valve 406 operation to provide synchronized fertigation functionality. The internal component arrangement shown in the exploded view may demonstrate how the first inlet 112, nozzle 116, flow rate assembly 402, connection tube 404, ball valve 406, power battery 408, power source 410, pump 412, venturi 421, and nozzle 116 work together to provide controlled mixing and dispensing capabilities within the fertigation apparatus 100.

FIG. 5 illustrates an exploded view of the fertigation apparatus of FIG. 1, in accordance with aspects of the present disclosure. Referring to FIG. 5, an inlet 114 is in fluid communication with an elbow 501 (or other geometrical component or attachment mechanism) and a conduit 430 to direct or receive chemical fluids through the inlet 114. In one embodiment, a container or reservoir may be coupled to the inlet 114 to supply one or more chemical elements or solutions to the system. The chemicals may be introduced into the flow path for controlled mixing and distribution with the primary fluid, such as water, within the fertigation apparatus.

In one embodiment, the one or more chemicals comprises one or more of a fertilizer, a pesticide, a herbicide, a biological, a fungicide, an insecticide, a soil amendment, fragrance, and combinations of the same and the like. In one embodiment, the fertilizer includes one or more of a nitrogen component, a phosphorous component, a potassium component, a micronutrient component and combinations of the same and the like. In one embodiment, the pesticide includes one or more of an insecticide/repellant component, a herbicide component, a fungicide component, a rodenticide component and combinations of the same and the like. In one embodiment, the biological includes one or more of a biostimulant component, a microbial inoculant component, a biofertilizer component, a biopesticide component and combinations of the same and the like. In one embodiment, the soil amendment includes one or more of a component configured to adjust pH, a pH adjustment component, a compost component, a surfactant component, a wetting agent and combinations of the same and the like. Of course, other chemicals or combination of chemicals as described may be utilized.

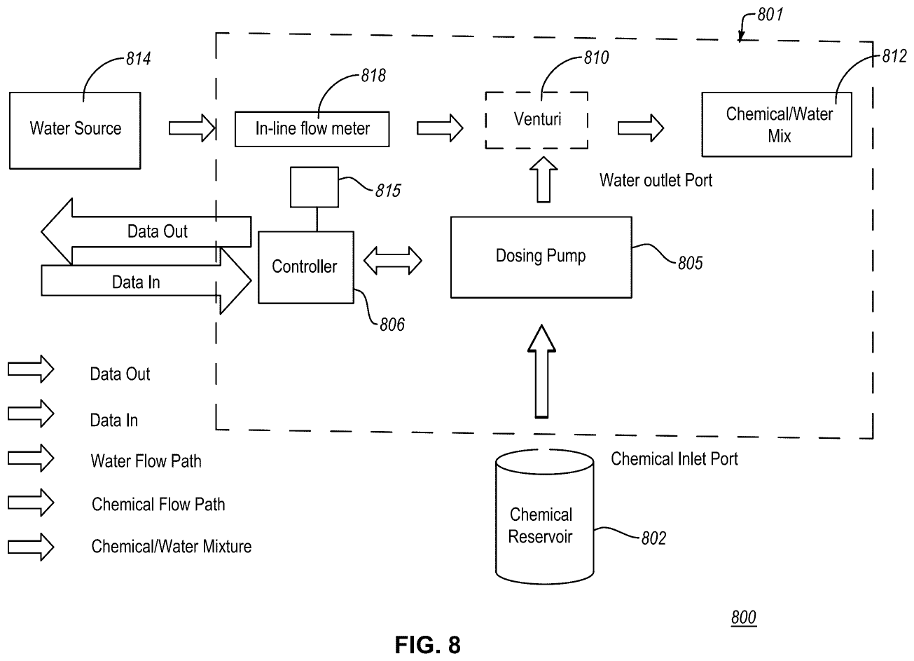

Optionally, and/or alternatively, the housing 100 may include a communication interface and a controller. The communication interface may be configured to enable wired or wireless communication over a network 800 described with reference to FIG. 8. In a preferred embodiment, the communication interface comprises a low-energy wireless communication unit configured to operate using one or more of the following protocols ZigBee, Z-Wave, Bluetooth Low Energy (BLE), Wi-Fi HaLow (IEEE 802.11ah), Low-Power Wide-Area Network (LPWAN), LoRaWAN, SigFox, Narrowband Internet of Things (NB-IoT), and LTE-M. Such low-power wireless communication enables energy-efficient connectivity suitable for remote or battery-operated agricultural systems. The controller may be operatively coupled to the communication interface and configured to receive control inputs or commands to operate the actuator and manage system functions.

Optionally, and/or alternatively, one or more sensors may be arranged in the housing 100 and configured to monitor one or more parameters indictive of pressure, flow rate, temperature, pH, electrical conductivity (EC), location, and chemical concentration. In certain embodiments, the controller may be communicatively coupled to one or more sensors configured to monitor system parameters such as pressure, flow rate, temperature, location, pH, electrical conductivity (EC), and chemical concentration. The controller may receive sensor data and process the information locally or transmit it through the communication interface to a remote computing device, cloud-based monitoring platform, or control server. In such embodiments, the system may support remote diagnostics, data logging, predictive maintenance, and automated adjustment of actuator settings based on real-time operating conditions. This integration enables precision control of fertigation operations while minimizing energy consumption and manual intervention.

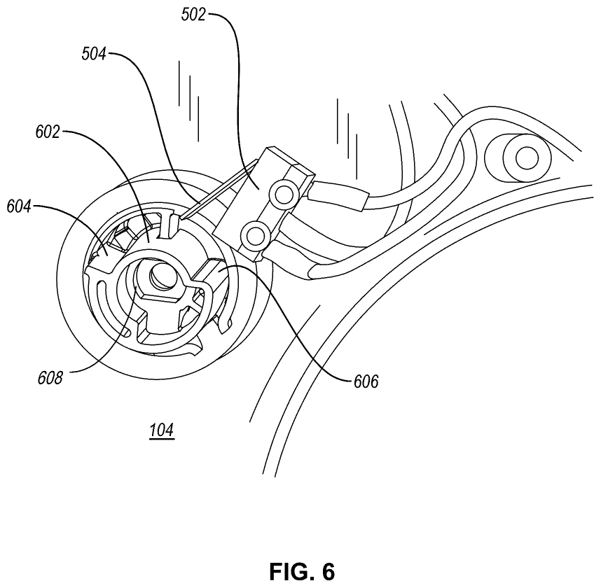

FIG. 6 illustrates a magnified exploded view of the fertigation apparatus showing a switch 502 with an activation member 504 according to aspects of the present disclosure. Referring to FIG. 6, the fertigation apparatus 100 may incorporate a switch 502 that may provide electrical control functionality for coordinating multiple operational systems within the apparatus. The switch 502 may be positioned within the housing 102 to enable activation of internal components when the actuator 104 is engaged by a user. The magnified view may demonstrate the spatial relationship between the switch 502 and other internal components, showing how the switch 502 may be mechanically or electrically connected to the actuator 604 to provide responsive control during operation of the fertigation apparatus 100.

The switch 502 may be configured to enable substantially simultaneous activation of both the pump 412 and the ball valve 406 when the actuator 104 is engaged. This simultaneous activation capability may provide coordinated operation that may ensure proper timing between chemical pumping operations and water flow control operations. The switch 502 may be designed as a multi-contact switching device that may provide separate electrical pathways for controlling the pump 412 and the ball valve 406, or may be configured as a single switching element that may trigger multiple control circuits simultaneously. In some cases, the switch 502 may incorporate electronic control logic that may manage the timing and sequencing of activation signals to ensure that the pump 412 and the ball valve 406 respond in a coordinated manner.

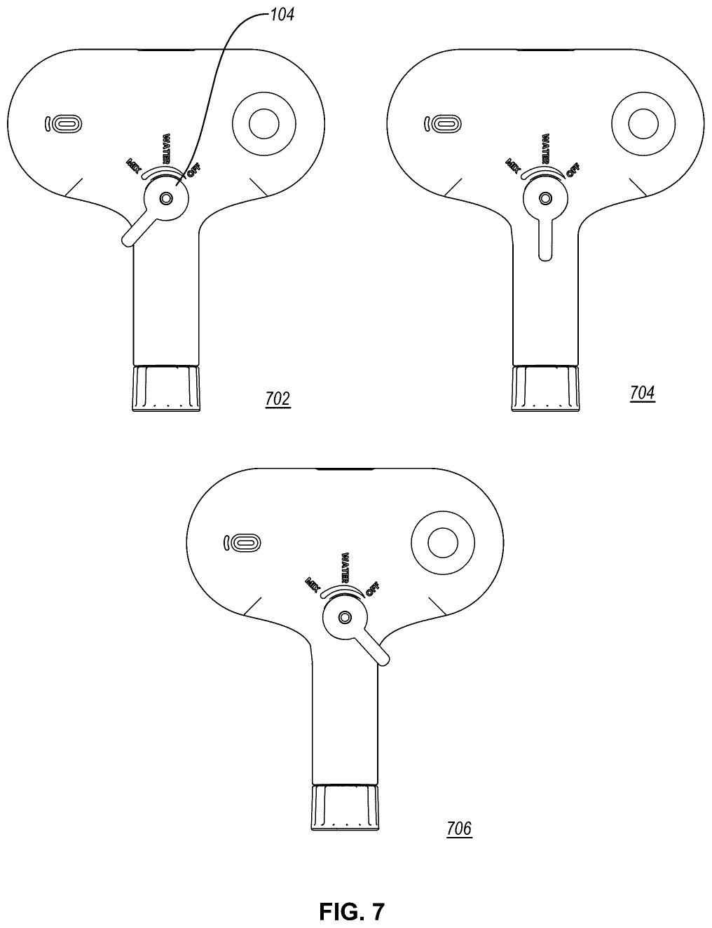

The actuator 104 may be mechanically coupled to the switch 502 through linkages, cam mechanisms, or direct contact arrangements that may translate user input motion into electrical switching action. In this embodiment, the actuator 104 includes an extended portion 602 with a first protrusion 604 and a second protrusion 606. The first protrusion 604 is sized and orientated to engage the mechanism 504 as the user rotates the actuator for a first position to a second position as described herein, e.g., with reference to FIG. 7.

The extended portion 602 includes a cutout 608 that is dimensioned and configured as a female receptacle adapted to interface with a valve having a corresponding male coupling or actuator. The female receptacle is shaped and sized to receive the male portion of the valve in a mating engagement such that, when coupled, mechanical communication is established between the two components. In operation, rotation of the actuator 104 by the user causes a corresponding rotational or translational movement of the valve element, thereby simultaneously activating or deactivating both the valve and the associated switch mechanism.

In one embodiment, the cutout 608 is specifically dimensioned to engage the actuator portion of the valve in a keyed or friction-fit arrangement that ensures rotational alignment. When the actuator 104 is rotated, the valve correspondingly opens or closes, providing fluid control synchronized with the switch actuation. Optionally, the coupling between the extended portion 602 and the valve can be reinforced by an auxiliary fastener or attachment mechanism, such as a screw, threaded insert, or locking clip, extending through the cutout 608. This secondary coupling enhances the mechanical stability of the assembly and prevents unintentional disengagement during operation, vibration, or pressure changes.

When a user engages the actuator 104, the mechanical motion may be transferred to the mechanism 504, causing the switch 502 to change state and provide electrical signals to control circuits associated with the pump 412 and the ball valve 406. The switch 502 may be constructed from materials that may provide reliable electrical contact performance and may maintain switching characteristics over extended operational periods. In some cases, the switch 502 may incorporate spring-loaded contacts or other mechanisms that may provide tactile feedback to users and may ensure positive switching action when the actuator 104 is engaged.

Optionally, and/or in an alternative embodiment, the switch 502 may be configured to simultaneously control both a pump and a valve assembly that includes a solenoid actuator. In this configuration, the switch 502 provides an electrical signal that concurrently energizes the pump and the solenoid, placing the valve mechanism in electrical communication with controller 408. Activation of the switch thereby causes the pump to initiate fluid movement while the solenoid actuates the valve to open or close a corresponding flow passage.

This synchronized operation allows the pump and valve to function in unison—such that, for example, when the switch is engaged, fluid is both driven by the pump and permitted to flow through the valve, and when the switch is disengaged, both the pump and valve are deactivated to halt fluid transfer. In some embodiments, the electrical circuit may incorporate a relay, timing delay, or controller to coordinate activation sequences, ensuring proper pressure buildup or controlled flow regulation.

The simultaneous activation capability provided by the switch 502 may enable the fertigation apparatus 100 to achieve precise control over mixing operations by coordinating the delivery of chemicals from the pump 412 with the opening of the ball valve 406 to allow water flow. This coordination may prevent situations where chemicals might be pumped without corresponding water flow, or where water flow might occur without chemical addition, either of which could result in improper mixing ratios or operational inefficiencies. The switch 502 may be electrically connected to the power source, e.g., battery 410 to receive electrical power and may provide switching signals to control circuits that may regulate the operation of the pump 412 and the ball valve 406. The magnified exploded view may show how the switch 502 may be integrated into the overall internal component arrangement while maintaining accessibility for connection to the actuator 104 and providing reliable switching performance during operation of the fertigation apparatus 100.

FIG. 7 illustrates a top view of the fertigation apparatus in different operational configurations, according to aspects of the present disclosure. Referring to FIG. 7, the fertigation apparatus 100 may be configured with multiple operational states that may be controlled through positioning of the actuator 104. The actuator 104 may be designed to provide discrete operational positions that may enable users to select specific functional modes for the fertigation apparatus 100. Each operational position may correspond to different internal component states and may provide distinct flow control characteristics that may be appropriate for various application requirements. The actuator 104 may be mechanically configured to maintain stable positioning in each operational state and may provide tactile feedback to users during position changes.

The fertigation apparatus 100 may include an off position 702 that may represent a non-operational state where internal components may be deactivated. In the off position 702, both the ball valve 406 and the pump 412 may be maintained in inactive states, preventing fluid flow through the fertigation apparatus 100. The off position 702 may provide a safe operational state that may be used during maintenance operations, storage periods, or when fertigation operations are not required. When the actuator 104 is positioned in the off position 702, electrical power to the pump 412 may be interrupted through the switch 502, and the ball valve 406 may be maintained in a closed configuration that may prevent water flow from the first inlet 112. The off position 702 may enable users to completely shut down fertigation operations while maintaining system integrity and preventing accidental activation of internal components.

The fertigation apparatus 100 may further include a water on position 704 that may enable water flow without chemical addition. In embodiment, in the water on position 704, the valve is about twenty five percent to about seventy five percent open, which allows water emitted from the first inlet 112 through internal flow pathways and may exit through the nozzle 116 without mixing with chemicals or other treatment materials. The water on position 704 may be achieved by opening the ball valve 406 to allow pressurized water flow while maintaining the pump 412 in an inactive state. This operational configuration may be useful for system flushing operations, water distribution without chemical treatment, or testing of water flow characteristics through the fertigation apparatus 100. When the actuator 104 is positioned in the water on position 704, the ball valve 406 is partially opened and the switch 502 has not been activated, thereby preventing activation of the pump 412, ensuring that only water only flows through the system. In this embodiment, in the water on position 704, the valve is about twenty five percent to about seventy five percent open, which allows water emitted from the first inlet 112 through internal flow pathways and may exit through the nozzle 116 without mixing with chemicals or other treatment materials.

The fertigation apparatus 100 may also include a fertilizer position 706 that may enable full fertigation functionality with simultaneous activation of the valve to be open at about one hundred percent open. In the fertilizer position 706, both the pump 412 and the ball valve 406 may be activated to provide coordinated delivery of chemicals and water to the nozzle 116 for mixing operations. The fertilizer position 706 may represent the primary operational mode for fertigation applications where controlled mixing of treatment materials with water may be required. When the actuator 104 is positioned in the fertilizer position 706, the switch 502 may provide simultaneous electrical activation signals to both the pump 412 and the ball valve 406, enabling coordinated operation that may ensure proper mixing ratios and flow characteristics. The pump 412 may draw chemical materials from the second inlet 114 and may deliver the chemicals to the nozzle 116, while the ball valve 406 may allow pressurized water flow from the first inlet 112 to combine with the chemical flow within the nozzle 116.

The three operational positions may provide users with precise control over fertigation operations and may enable selection of appropriate functional modes based on specific application requirements. The actuator is configured to be operated with one hand of the user, e.g., via a thumb of a user. The actuator 104 may be configured with mechanical detents, stops, or other positioning mechanisms that may ensure accurate placement in each of the off position 702, the water on position 704, and the fertilizer position 706. In some cases, the actuator 104 may include visual indicators, markings, or labels that may identify each operational position and may provide guidance to users during operation. The positioning mechanism of the actuator 104 may be designed to prevent inadvertent movement between positions and may require deliberate user action to change operational states. The flow control characteristics provided by each position may enable the fertigation apparatus 100 to accommodate various operational scenarios while maintaining consistent performance and reliable component operation across different functional modes.

FIG. 8 illustrates a diagram of an exemplary fertigation system, according to aspects of the present disclosure. Referring to FIG. 8, a fertigation system 800 may be configured to provide comprehensive chemical delivery and mixing capabilities for agricultural and horticultural applications. The fertigation system 800 may incorporate multiple interconnected components that may work together to provide controlled chemical dosing, precise mixing operations, and automated treatment delivery functionality. The fertigation system 800 may be designed to accommodate various chemical formulations and may provide scalable treatment capabilities that may be adapted to different application requirements and operational environments.

The fertigation system 800 may include a chemical reservoir 802 that may be configured to store treatment materials in liquid or dissolved form for delivery to mixing components. The chemical reservoir 802 may be constructed from materials that may provide chemical compatibility with various fertilizers, pesticides, herbicides, biologicals, fungicides, insecticides, soil amendments, and fragrances that may be used in fertigation applications. In some cases, the chemical reservoir 802 may be designed with capacity specifications that may accommodate different treatment volumes and may enable extended operational periods without requiring frequent refilling operations. In one embodiment, the chemical reservoir is in fluid communication with inlet 114. The chemical reservoir 802 may incorporate level sensing capabilities, venting systems, or agitation mechanisms that may maintain chemical homogeneity and may prevent settling or separation of treatment materials during storage periods.

As shown, the chemical flow path is shown and there is fluid communication between the chemical reservoir 802 and downstream mixing components within the fertigation system. The chemical flow path may be configured with appropriate tubing, fittings, and connection mechanisms that may enable reliable chemical transfer while maintaining system integrity and preventing leakage. The chemical flow path may be constructed from materials that may provide chemical resistance and may maintain flow characteristics over extended operational periods. In some cases, the chemical flow path may incorporate flow restriction devices, check valves, or pressure regulation components that may control chemical delivery rates and may prevent backflow conditions that could compromise system performance or chemical integrity.

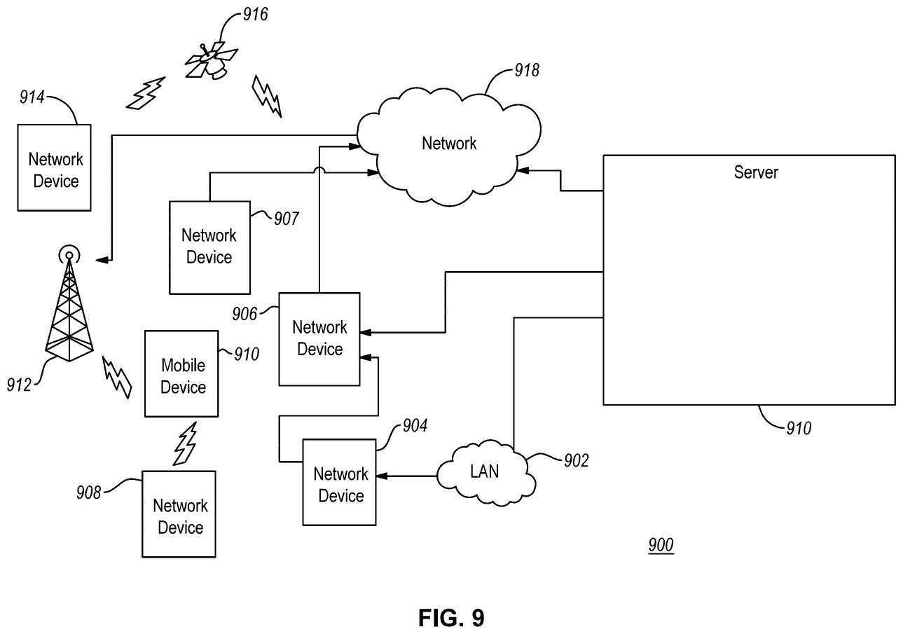

The fertigation system 800 may incorporate a controller including 806, e.g., a PCB, memory and/or other electronic components configured to provide electronic control functionality for various system components and operational parameters. The controller is in communication with a communication interface 815 to provide communication over the network 900 or between components. The controller 806 may include microprocessor capabilities, memory storage, input/output interfaces, and communication circuits that may enable automated control of chemical dosing operations and system monitoring functions. The controller 806 may be configured to receive sensor inputs, process control algorithms, and generate output signals that may regulate the operation of pumps, valves, and other electromechanical components within the fertigation system 800. In some cases, the controller 806 may incorporate wireless communication capabilities that may enable remote monitoring and control of fertigation operations through mobile devices or network-based systems, e.g., as shown in FIG. 9 and set forth herein.

A dosing pump 805 may be positioned along the chemical flow path to provide controlled movement of chemical materials from the chemical reservoir 802 to mixing locations within the fertigation system 800. The dosing pump 805 may be configured as a positive displacement pump that may provide accurate flow control and may be capable of handling various chemical viscosities and formulations. The dosing pump 805 may be electrically controlled through the controller 806 and may be configured to operate at predetermined duty cycles that may enable precise chemical delivery rates. In some cases, the dosing pump 805 may comprise a continuous pump that may be modulated at a predetermined duty cycle within a range of 0.1-10 Hz or greater, enabling fine control over chemical delivery rates and mixing ratios. The dosing pump 805 may alternatively be configured as a peristaltic pump, gear pump, or diaphragm pump that may provide chemical isolation and may reduce maintenance requirements associated with chemical contact with internal pump components. In one embodiment, the dosing pump 805 is the pump 412 and the system 801 is configured in the housing 100 as set forth herein with reference to FIGS. 1-7. In one embodiment, each of the modules 806, 818, 810, 812, and 805 are in communication with each other and the network 900.

Optionally, and/or alternatively, the fertigation system 800 may include a venturi 810 that may be positioned to receive inputs from both the dosing pump 805 and external water sources for mixing operations. The venturi 810 may be configured to create controlled mixing conditions that may combine chemical materials delivered by the dosing pump 805 with pressurized water to achieve predetermined concentration ratios. The venturi 810 may utilize fluid dynamics principles to create mixing action and may be designed to provide consistent mixing performance across various flow rates and pressure conditions. In some cases, the venturi 710 may be constructed with internal geometries that may enhance mixing efficiency and may reduce the potential for chemical stratification or incomplete mixing during operation of the fertigation system 800.

A water source 814 may provide pressurized water input to the fertigation system 800 and may be connected to the venturi 810 through appropriate flow control mechanisms. The water source 814 may be configured to accommodate various water supply systems including municipal water networks, well water systems, or pressurized irrigation infrastructure. The water source 814 may provide water at pressures that may be compatible with the operational requirements of the venturi 810 and may enable effective mixing with chemical materials delivered through the chemical flow path. The fertigation system 800 may be configured to operate with water from the water source 814 at static pressures ranging from about 40 psi to about 80 psi, and may function during dynamic flow conditions with pressures ranging from about 1 psi to about 40 psi.

The venturi 810 may combine chemical and water inputs to create a chemical water mix 812 that may flow through downstream distribution systems to application locations. The chemical water mix 812 may be formulated to achieve specific concentration ratios that may be appropriate for various treatment applications and crop requirements. The mixing process within the venturi 810 may be controlled through coordination between the dosing pump 808 operation and water flow from the water source 814, enabling precise control over the final concentration characteristics of the chemical water mix 812. In some cases, the chemical water mix 812 may be monitored through sensor systems that may provide feedback to the controller 806 regarding concentration levels, flow rates, or other operational parameters that may affect treatment effectiveness.

The fertigation system 800 may incorporate an inline flow meter 818 that may be positioned to monitor flow characteristics of the chemical water mix 812 or individual fluid streams within the system. The mix can be achieved via the nozzle 116 as described herein. The inline flow meter 818 may provide flow rate measurements, volumetric flow data, or other flow-related information that may be transmitted to the controller 806 for processing and control purposes. The inline flow meter 818 may enable real-time monitoring of system performance and may provide data that may be used for automated control adjustments, treatment documentation, or system diagnostics. In some cases, the inline flow meter 818 may be configured with communication capabilities that may enable transmission of flow data to external monitoring systems or mobile devices for remote system oversight.

The fertigation system 800 may include a lawn treatment plan engine that may be configured to provide comprehensive treatment planning and delivery coordination capabilities. The lawn treatment plan engine may be implemented through software applications running on the controller 806, external computing systems, or distributed processing networks that may communicate with the fertigation system 800. The lawn treatment plan engine may be configured to query a customer for an address having a lawn and may receive the address information through user interface systems or automated data collection methods. The lawn treatment plan engine may calculate an initial lawn size for the lawn based on the address information, utilizing geographic databases, satellite imagery, or property records that may provide area measurements and landscape characteristics. Again, the system 800 can be housed in the apparatus 100 as described herein.

The lawn treatment plan engine may receive confirmation of the initial lawn size through user input systems, field measurements, or verification processes that may ensure accuracy of area calculations. Following size confirmation, the lawn treatment plan engine may calculate a lawn treatment plan based on the initial lawn size and may incorporate factors such as grass type, soil conditions, climate data, seasonal requirements, and treatment objectives. The treatment plan calculations may determine chemical application rates, treatment schedules, seasonal adjustments, and specific product recommendations that may be appropriate for the identified lawn characteristics and customer requirements. The lawn treatment plan engine may provide instructions for delivering packetized lawn treatments according to the lawn treatment plan on a periodic basis, coordinating treatment timing with seasonal growth patterns, weather conditions, and customer preferences. The packetized treatments may be formulated with specific chemical concentrations and volumes that may correspond to the calculated lawn size and treatment requirements, enabling precise application through the fertigation system 800 components including the chemical reservoir 802, dosing pump 805, and venturi 810 mixing operations.

FIG. 9 illustrates an exemplary block diagram of an exemplary communication network, according to aspects of the present disclosure. Referring to FIG. 9, communication network 900 includes one or more networks, including wide-area network 918, e.g., the Internet, company or organization Intranet, and/or sections of the Internet (e.g., virtual private networks, Clouds, and the Dark Web), and local-area network 902, e.g., interconnected computers localized at a geographical and/or organization location and ad-hoc networks connected using various wired means, e.g., Ethernet, coaxial, fiber optic, and other wired connections, and wireless means, e.g., low power communication unit is configured to utilize one or more of ZigBee protocol, Z-Wave protocol, Bluetooth Low Energy (BLE) protocol, Wi-Fi HaLow (IEEE 802.11 ah) protocol, LPWAN protocol, LoRaWAN protocol, SigFox protocol, NB IoT protocol, and LTE-M protocol, Wi-Fi, Bluetooth, and other wireless connections. Communication network 900 includes a number of network devices 904, 906, 907, 908, and 914 that are in communication with the other devices through the various networks 918 and 902 and through other mechanisms, e.g., direct connection through an input/output port of a network device 904, direct connection through a wired or wireless means, and indirect connection through an input-output box, e.g., a switch.

Network devices 904, 906, 907, 908 and 914, may also connect through the networks 918 and 902 using various routers, access points, and other means. For example, network device 908 wirelessly connects to a base station 912, which acts as an access point to the wide area network 918. Base station 912 may be a cellular phone tower, a Wi-Fi router or access point, or other devices that allow a network device, e.g., wireless network device 908, to connect to a network, e.g., wide area network 918, through the base station 912. Base station 912 may be connected directly to network 918 through a wired or wireless connection or may be routed through additional intermediate service providers or exchanges. Wireless device 908 connecting through base station 912 via a mobile device 910 or may also act as a mobile access point in an ad-hoc or other wireless network, providing access for network device 914 through network device 908 and base station 912 to network 918.

In some scenarios, there may be multiple base stations, each connected to the network 918, within the range of network device 908. In addition, a network device, e.g., network device 908, may be travelling and moving in and out of the range of each of the multiple base stations. In such case, the base stations may perform handoff procedures with the network device and other base stations to ensure minimal interruption to the network device's connection to network 918 when the network device is moved out of the range of the handling base station. In performing the handoff procedure, the network device and/or the multiple base stations may continuously measure the signal strength of the network device with respect to each base station and handing off the network device to another base station with a high signal strength to the network device when the signal strength of the handling base station is below a certain threshold.

In another example, a network device, e.g., network device 918, may wirelessly connect with an orbital satellite 916, e.g., when the network device is outside of the range of terrestrial base stations. The orbital satellite 916 may be wirelessly connected to a terrestrial base station that provides access to network 918 as known in the art.

In other cases, orbital satellite 918 or other satellites may provide other functions such as global positioning and providing the network device with location information or estimations of location information of the network device directly without needing to pass information to the network 918. The location information or estimation of location information is known in the art. The network device may also use geolocation methods, e.g., measuring and analyzing signal strength, using the multiple base stations to determine location without needing to pass information to the network 918. In an embodiment, the global positioning functionality of the orbital satellite 916 may use a separate interface than the communication functionality of the orbital satellite 916 (e.g., the global position functionality uses a separate interface, hardware, software, or other components of the network device 908 than the communication functionality). In another embodiment, the orbital satellite with the global position functionality is a physically separate satellite from the orbital satellite with communication functionality.

In one scenario, network device, e.g., network device 904, may connect to wide area network 918 through the local area network 902 and another network device, e.g., network device 904. Here, the network device 904 may be a server, router, gateway, or other devices that provide access to wide area network 918 for devices connected with local area network 902.

A number of implementations have been described. Nevertheless, it will be understood that various modifications may be made without departing from the spirit and scope of the disclosure. Accordingly, other implementations are within the scope of the following claims. The server 910 can include an input/output device, processor, memory and storage as known in the art. The network 900 can include one or more mobile device 910 for use with the network.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as a discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this description, with each claim standing on its own as a separate preferred embodiment of the disclosure.

Moreover, though the description has included a description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A fertigation apparatus, comprising:
a housing comprising:
a first inlet configured to receive pressurized water;
a second inlet configured to receive one or more chemicals;
a pump in fluid communication with the second inlet;
a power source configured to provide power to the pump;
a flexible housing conduit in fluid communication with the pump;
an actuator in electronic communication with the power source and the pump, wherein when the actuator is activated it substantially simultaneously activates the pump and a valve to allow flow from the first inlet; and
a nozzle in fluid communication with the first inlet and the second inlet, wherein the nozzle is in fluid communication with the pump and configured to mix the one or more chemicals and water at a predetermined concentration.

2. The fertigation apparatus of claim 1, wherein the fertigation apparatus further comprises a sensor configured to measure one or more of a flowrate, a volumetric flow rate, a concentration of the one or more chemicals, flow, whether the fertigation apparatus is on or off, and information indicative of an identification of the one or more chemicals.

3. The fertigation apparatus of claim 1, wherein the fertigation apparatus further comprises a wireless low power communication unit configured to be in communication with one of a mobile device or a computer.

4. The fertigation apparatus of claim 1, wherein the pressurized water has a pressure in a range from about 40 psi to about 80 psi in static/non-flow pressure state.

5. The fertigation apparatus of claim 1, wherein the pump comprises one or more of a peristaltic pump, a gear pump, or a diaphragm pump with or without the presence of a venturi restriction.

6. The fertigation apparatus of claim 1, wherein the one or more chemicals comprise one or more of a fertilizer, a pesticide, a herbicide, a biological, a fungicide, an insecticide, a soil amendment, and a fragrance.

7. A fertigation apparatus, comprising:
a housing comprising:
a first inlet configured to receive pressurized water;
a second inlet configured to receive one or more chemicals;
a pump in fluid communication with the second inlet;
a power source configured to provide power to the pump;
a flexible housing conduit in fluid communication with the pump;
an actuator in electronic communication with the power source and the pump, wherein when the actuator is activated it substantially simultaneously activates the pump and a valve, wherein the valve is configured to allow flow from the first inlet; and
a nozzle in fluid communication with the first inlet and the second inlet, wherein the nozzle is in fluid communication with the pump and configured to mix the one or more chemicals and water at a predetermined concentration, and wherein the nozzle does not have a vacuum or a lower pressure during operation.

8. The fertigation apparatus of claim 7, wherein the fertigation apparatus further comprises one or more of a position sensor, a location sensor, an accelerometer sensor, a temperature sensor, and a radar sensor.

9. The fertigation apparatus of claim 7, wherein the wireless low power communication unit is configured to utilize one or more of ZigBee protocol, Z-Wave protocol, Bluetooth Low Energy (BLE) protocol, Wi-Fi HaLow (IEEE 802.11 ah) protocol, LPWAN protocol, LoRaWAN protocol, SigFox protocol, NB IoT protocol, and LTE-M protocol.

10. The fertigation apparatus of claim 7, wherein the power source comprises one or more of a battery, solar power, and hydropower via turbine inline.

11. The fertigation apparatus of claim 7, wherein the pump comprises a continuous pump configured to be modulated at a predetermined duty cycle within a range of 0.1-10 Hz or greater.

12. The fertigation apparatus of claim 7, wherein the actuator is configured to provide multiple operational positions including an off position, a water on position, and a fertilizer position.

13. A fertigation apparatus, comprising:
a housing comprising:
a first inlet configured to receive pressurized water;
a second inlet configured to receive one or more chemicals;
a pump in fluid communication with the second inlet;
a power source configured to provide power to the pump;
a flexible housing conduit in fluid communication with the pump;
an actuator in electronic communication with the power source and the pump;
a controller in communication with a wireless low power communication unit, wherein the controller is configured to actuate the actuator in response to an input; and
a nozzle in fluid communication with the first inlet and the second inlet, wherein the nozzle is in fluid communication with the pump and configured to mix the one or more chemicals and water at a predetermined concentration.

14. The fertigation apparatus of claim 13, wherein the housing is constructed from one or more materials including plastic material, thermoplastic material, PVC material, and PEEK material.

15. The fertigation apparatus of claim 13, wherein the housing utilizes a clam shell design configuration that enables access to internal components.

16. The fertigation apparatus of claim 13, wherein the nozzle includes a chemical outlet from a bottom portion of the nozzle configured to provide one or more chemicals into the pressurized water inlet.

17. The fertigation apparatus of claim 13, wherein the nozzle further includes a nozzle ramp positioned at an angle of about 11 degrees.

18. The fertigation apparatus of claim 13, wherein the fertigation apparatus further comprises a printed circuit board and the power source comprises a battery that powers electronics having one or more of a controller, microcontroller, printed circuit board, low power communication source, and memory.

19. A fertigation system, comprising:
a fertigation apparatus comprising a housing, the housing comprising:
a first inlet configured to receive pressurized water;
a second inlet configured to receive one or more chemicals;
a pump in fluid communication with the second inlet;
a power source configured to provide power to the pump;
a flexible housing conduit in fluid communication with the pump;
an actuator in electrical communication with the power source and the pump, wherein when the actuator is activated it substantially simultaneously provides power to the pump and opens a valve configured to allow flow from the first inlet; and
a nozzle in fluid communication with the first inlet and the second inlet, wherein the nozzle is in fluid communication with the pump and configured to mix the one or more chemicals and water at a predetermined concentration;
a sensor module;
a wireless communication unit; and
a controller electrically connected to the wireless communication unit and the sensor module, the controller being configured to establish a communication link to a wireless mobile device using a short-range wireless communication protocol including sending information indicative of one or more: information indicative of an identification of the fertigation apparatus, information indicative of a user identification, information indicative of a treatment time, information indicative of a treatment location, information indicative of a treatment concentration, and information indicative of the one or more chemicals; and
a network based data processing system comprising a data storage system and a processor, configured to receive data from the wireless mobile device.

20.-60. (canceled)
